(19) United States
(12) Patent Application Publication
(10) Pub. No.: US 2003/0041807 A1
(43) Pub. Date: Mar. 6, 2003

(54) Animal bed

(76) Inventors: Christopher Carl Wulforst, Boiling Springs, SC (US); Kyle Garrod Gipson, Simpsonville, SC (US); Duff Bernard Wagner, Taylors, SC (US)

Correspondence Address: Milliken & Company, P.O. Box 1927, Spartanburg, SC, 29304, US

(21) Appl. No.: 09/940,744

(22) Filed: Aug. 28, 2001

(51) Int. Cl. A01K 29/00

(52) U.S. Cl. 119/28.5

(57) ABSTRACT

An animal bed having an cushioning core material surrounded by an encasing. The encasing has a face textile, odor adsorbing layer, and a backing material. The odor adsorbing layer includes a odor adsorbing agent adhered to an interior of the face textile. The backing layer covers the odor adsorbing layer.

### BACKGROUND

The present invention relates to bedding articles for animals, and in particular to bedding articles for odor control.

Animal bedding provides a surface for an animal, such as a pet to rest which is typically more comfortable than the ground or conventional floors. However, the repeated use of such beds by animals can create odors on and in the bed. Therefore, there is a need for animal beds which can reduce or control odors.

### BRIEF DESCRIPTION OF THE DRAWINGS

FIG. 1 is a perspective view of an animal bed incorporating the present invention.

FIG. 2 is a partial cross sectional view of one embodiment of the animal bed of the present invention.

FIG. 3 is a partial cross sectional view of another embodiment of the animal bed according to the present invention.

FIG. 4 is a enlarged partial cross sectional view of an embodiment of the casing of the present invention.

### DETAILED DESCRIPTION

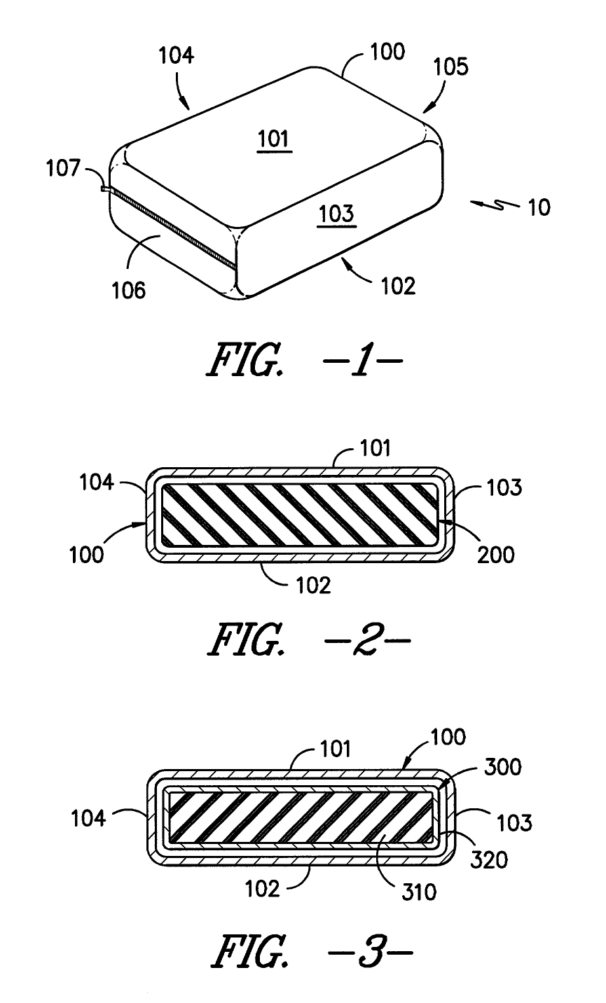

Referring now to the drawings, and in particular to FIG. 1, there is illustrated an animal bed 10 according to the present invention. The animal bed 10 includes an encasing 100. The encasing has a top surface 101, a bottom surface 102, side walls 103, 104, and 105, and an enclosure end 106 with a closure member 107. The closure member 107 can be a zipper closure member, a hook and pile closure member, a series of buttons and button holes, or the like. Although the animal bed 10 has been illustrated in FIG. 1 as a square-pillow type configuration, it is understood that the animal bed 10 can be any shape that will accommodate an animal which would rest on the animal bed 10.

Referring now to FIG. 2, there is shown a partial cross sectional view of one embodiment of the animal bed 10 illustrated in FIG. 1. As illustrated in FIG. 2, the animal bed 10 includes the encasing 100 surrounding a core 200. The core 200 is preferably a cushioning material, such as foam, polyester fiber, chipped or shredded cedar wood or the like.

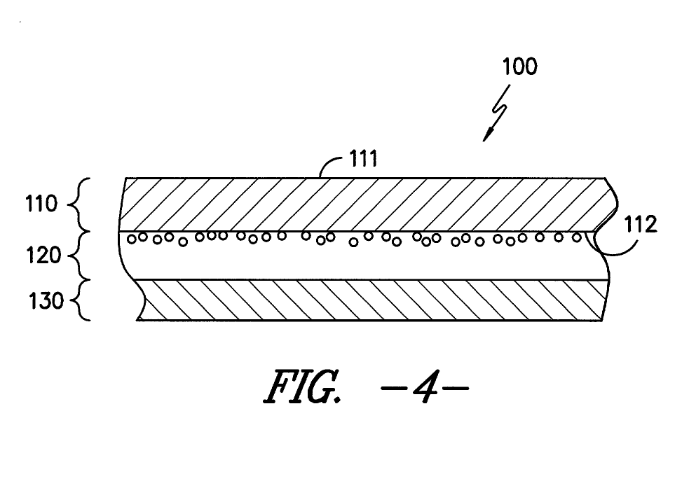

Referring now to FIG. 3, there is shown a partial cross section of the animal bed 10 in FIG. 1, having the encasing 100 surrounding a core 300. As illustrated in FIG. 3, the core 300 includes a cushioning material 310 surrounded by a lining 320. The cushioning material 310 can be a foam, polyester fibers, shredded or chipped cedar, or the like. The lining 320 can be a material of nonwoven, woven, knitted, or the like.

Referring now to FIG. 4, there is shown an enlarged partial cross sectional view of the encasing 100 of the present invention from FIG. 1. The encasing 100 generally includes a face textile 110 and an odor receiving layer 120. The face textile 100 has an exterior surface 111 and a interior surface 112. The odor receiving layer 120 is typically disposed on the interior surface 112 of the face textile 110. In one embodiment, the encasing 100 can include a backing material 130 disposed adjacent to, and protecting, the odor receiving layer 120.

The face textile 110 can be a knit, woven, nonwoven, or the like. The material of the face textile 110 can be a synthetic material, a natural material, or a blend thereof. Synthetic materials that can be used for the face textile 100 include polyester, nylon, acrylic, rayon, or any other simple fabric. Natural fibers which can be used for the face textile 110 include cotton, linen, ramie or any other suitable material. In one embodiment, the face textile 110 is a 100% polyester warp knit pile fabric having a weight of about 6.6 ounces per square yard.

The exterior surface 111 of the face textile 110 can be treated to provide a more desirable surface, both in feel and performance. For example, the exterior surface 111 of the face textile 110 may be sanded to provide a more softer feeling fabric. Also, the face textile 110 can be treated with various treatments such as anti-microbial agents, fire retardant agents, UV inhibiting agents, water resisting agents, stain resisting agents, or the like. For example, fluorocarbon treatments can be applied to the outer surface 111 of the face material 110 to inhibit stains and to repel water.

The odor receiving layer 120 will contain an odor receiving agent for attracting and holding odors. The odor receiving agent can be a odor absorbing agent, and/or an odor adsorbing agent. Odor absorbing agents receive the odor and trap that odor inside the agent. Odor adsorbing agents receive the odor and hold the odor on the exterior of the agent. The odor adsorbing agent has the added advantage that odor can be released and the agent refreshed for additional use if the agent is subjected to heat, such as from a clothes dryer.

The odor receiving agent of the odor receiving layer 120 can be a particulate odor receiving agents, such as activated charcoal, zeolite compounds, or the like. Particulate odor receiving agents provide a greater surface area for receiving the odorous material. A carbonaceous material that can be converted into an activated carbon for the present invention include materials such as coal (bituminous), coconut shells, coke, peat, petroleum fractions, wood chips (saw dust), or the like. Other less common materials that can be used for forming activated carbon include automobile tires, cherry stones, coffee grounds, corn cobs, plastic waste, sewage sludge, straw, water lilies, or the like. Performance of the activated charcoal is typically improved with greater pore size and surface area. Generally, the smaller the particulate size, the better the odor receiving capability of the odor receiving agent. In one embodiment, the odor receiving agent has a 100×150 screened particle size, and is distributed on the interior surface 111 of the face textile 110 at a rate of from about 1.5 ounces per square yard to about 3 ounces per square yard.

The odor receiving agent of the odor receiving layer 120 can be adhered to the interior surface 112 of the face textile by an adhesive, such as a powder or film adhesive. In one embodiment, the adhesive is a hot melt adhesive. In a preferred embodiment, the adhesive is a hot melt film adhesive, such as a film of a copolyamide adhesive having a weight of from about 1 ounce per square yard to about 3 ounces per square yard. The hot melt adhesive is bonded to the odor receiving agent and the face fabric 110 through the application of heat. In the embodiment using a film adhesive, the odor receiving agent, such as activated charcoal, can be placed on the interior surface 111 of the face textile 110 and then the adhesive film is placed on the odor receiving agent prior to the application of heat, or the odor receiving agent can be placed on the adhesive film and then the interior surface 111 of the face fabric 110 placed on the odor receiving agent prior to the application of heat.

In one embodiment, the odor receiving layer 120 is disposed over the entire interior surface 111 of the face textile 110. However, the odor receiving layer 110 can be dispose over the interior surface 111 of the face textile 110 in only one area of the encasing 100, such as the top surface 101 area of the encasing 100, or a combination of areas of the encasing 100.

In an embodiment having a backing material 130, the backing material 130 can be a textile, a film, or the like. The backing material 130 can also be adhered to the odor receiving layer 120 by the adhesive of the odor receiving layer 120.

In the embodiment where the backing material 130 is a textile, the textile can be a knit, woven, nonwoven, or the like, and can be formed of synthetic, natural, or a blend thereof, similar to the face textile 110. In one embodiment, the backing material 130 is a point bonded nonwoven polyester material, formed of about 2.6 denier per filament and having a weight of less than about 1 ounce per square yard.

In the embodiment where the backing material 130 is a film, the film can be a low density polyethylene film of about 2 ounces per square yard. In this embodiment, the film of the backing material 130 can be a multilayer film having the adhesive film for securing the odor receiving agent to the face textile 110. In this manner, the used in the application of the adhesive and the backing material 130 can occur under the same step of assembly.

What is claimed is:

1. An animal bed encasing for enclosing cushioning core, the encasing comprising an enclosure having:
a face textile with an exterior surface and an interior surface;
an odor receiving layer disposed on the interior surface of the face textile.

2. The animal bed encasing according to claim 1, wherein said odor receiving layer comprises an absorbing agent.

3. The animal bed encasing according to claim 1, wherein said odor receiving layer comprises an adsorbing agent.

4. The animal bed encasing according to claim 3, wherein said odor adsorbing agent comprises activated charcoal.

5. The animal bed encasing according to claim 4, wherein said activated charcoal has a about a 100×150 particle screened size, and is distributed on the interior surface of the face textile at a rate of from about 1

6. The animal bed encasing according to claim 1, wherein said odor receiving layer includes an adhesive.

7. The animal bed encasing according to claim 6, wherein said adhesive is a hot melt adhesive.

8. The animal bed encasing according to claim 7, wherein said hot melt adhesive is a film securing the activated charcoal against the interior surface of said textile.

9. The animal bed encasing according to claim 1, further including a backing material disposed adjacent to the odor adsorbing layer.

10. The animal bed encasing according to claim 9, wherein said backing material comprises a backing textile.

11. The animal bed encasing according to claim 10, wherein the backing textile comprises a point bonded nonwoven material.

12. The animal bed encasing according to claim 9, wherein said backing material comprises a film.

13. The animal bed encasing according to claim 1, wherein the film of said backing material comprises a low density polyester film.

14. An animal bed encasing for enclosing cushioning core, the encasing comprising an enclosure having:
a face textile with an exterior surface and an interior surface;
an odor receiving layer disposed on the interior surface of the face textile, said odor receiving layer including:
activated charcoal;
adhesive; and,
a backing material disposed adjacent to the odor receiving layer.
